(19) United States
(12) Patent Application Publication
(10) Pub. No.: US 2026/0331672 A1
(43) Pub. Date: Oct. 22, 2026

(54) BATTERY ASSEMBLY

(71) Applicants: Hyundai Motor Company, Seoul (KR); Kia Corporation, Seoul (KR)

(72) Inventors: Do Hyeon KIM, Hwaseong-Si (KR); Ju Yong PARK, Hwaseong-Si (KR); Hyun Ho LEE, Hwaseong-si (KR); Su Eon KIM, Hwaseong-si (KR)

(73) Assignees: Hyundai Motor Company, Seoul (KR); Kia Corporation, Seoul (KR)

(21) Appl. No.: 19/693,219

(22) Filed: May 29, 2026

(30) Foreign Application Priority Data
Dec. 1, 2025 (KR) 10-2025-0187363

(51) Int. Cl. H01M 50/242; H01M 50/262; H01M 50/291

(52) U.S. Cl. CPC H01M 50/242; H01M 50/262; H01M 50/291

(57) ABSTRACT

A battery assembly includes: a support member disposed in a battery case; a battery cell array configured with a plurality of battery cells and accommodated in the battery case so that the battery cells are disposed at one side of the support member in a stacked and pressurized state; an end plate disposed at an upper end portion of the support member and pressurizing the battery cells from an external side of the battery cell array; and a fastening mechanism fastening the end plate and the support member in a vertical direction.

### CROSS-REFERENCE TO THE RELATED APPLICATION

The present application claims priority from Korean Patent Application No. 10-2025-0187363 filed on Dec. 1, 2025, in the Korean Intellectual Property Office, the present disclosure of which is incorporated herein by reference in its entirety.

### BACKGROUND OF THE PRESENT DISCLOSURE

### Field of the Present Disclosure

The present disclosure relates to a battery assembly.

### Description of Related Art

A battery array is configured by stacking a plurality of battery cells, and electrical connection and mechanical support should be secured simultaneously. Since heat and expansion occur in each battery cell during a charging and discharging process, a support structure capable of withstanding the heat and expansion is required. Such a structure may control a shape change of a cell and serve to protect the cell from external impact or vibration. Therefore, mechanical stability of the battery array directly affects lifespan and performance maintenance of the cell.

Meanwhile, a pressurizing structure is often applied to maintain battery cells at a constant pressure. The pressurizing structure should transmit a uniform load to contact surfaces between a plurality of battery cells, and stress concentration or deformation at a specific portion may occur when the load acts non-uniformly. Furthermore, when minute deformation according to cell expansion is accumulated, uniformity of surface pressure may be degraded, and there is a possibility that electrical characteristics become unstable. Therefore, a structural design for maintaining balance of surface pressure is importantly considered.

Furthermore, an arrangement relationship between a support member and a fastening member constituting a battery module also affects surface pressure distribution and deformation behavior. When position alignment of a fastening portion is not constant or when a load is concentrated at a specific point, deformation of a component or loosening of the fastening portion may occur. Since such mechanical instability affects a contact state between cells and electrical reliability, design of a load transmission path and a fastening structure becomes a major consideration factor for securing performance of a battery module.

The matters described as the Description of Related Art above are only for enhancing understanding of the background of the present disclosure and should not be taken as an acknowledgement that they correspond to the related art already known to those of ordinary skill in the art.

### BRIEF SUMMARY

Various aspects of the present disclosure are directed to preventing reliability degradation due to load imbalance and structural deformation occurring in a battery cell stacking structure, and is directed to providing a battery assembly configured for securing mechanical strength and assembly precision while stably maintaining a pressurized state of a cell.

Technical problems to be achieved in the present disclosure are not limited to the technical problems mentioned above, and other technical problems not mentioned may be clearly understood by those of ordinary skill in the art to which the present disclosure belongs from the description below.

According to various aspects of the present disclosure, a battery assembly of the present disclosure for achieving the above object may include: a support member disposed in a battery case; a battery cell array configured with a plurality of battery cells and accommodated in the battery case so that the battery cells are disposed at one side of the support member in a stacked and pressurized state; an end plate disposed at an upper end portion of the support member and pressurizing the battery cells from an external side of the battery cell array; and a fastening mechanism fastening the end plate and the support member in a vertical direction.

According to various aspects of the present disclosure, a direction in which the support member supports the battery cell array and a direction in which the end plate pressurizes the battery cell array may be identical to each other.

According to various aspects of the present disclosure, the end plate may be disposed in a plate shape and disposed between the support member and the battery cell array, a first side surface of the end plate may be in contact with the battery cell array to pressurize the battery cells, and a protrusion portion protruding in a direction toward the support member and covering an upper surface of the support member may be disposed on a second side surface.

According to various aspects of the present disclosure, the end plate may further include a base portion extending in a direction in which the support member extends between the first side surface and the second side surface, and the fastening mechanism may be connected to the upper surface of the support member by passing through the end plate in a state of being disposed on an upper surface of the base portion or the protrusion portion.

According to various aspects of the present disclosure, the protrusion portion may protrude on the end plate in a direction from a first side toward a second side of the support member and extend to cover a center portion disposed between the first side and the second side of the support member.

According to various aspects of the present disclosure, the second side surface of the end plate may include the protrusion portion disposed at an upper portion thereof, and as a lower portion thereof is disposed between the support member and the battery cell array, the support member may include an upper surface covered by the protrusion portion and one side surface facing the battery cell array covered by the second side surface of the end plate.

According to various aspects of the present disclosure, adjacent end plates among the end plates may be disposed so that the protrusion portions alternately cross each other at the upper surface of the support member.

According to various aspects of the present disclosure, the end plate may include a base portion disposed between one side surface in contact with an external side of the battery cell array and another side surface in contact with the support member and extending along a direction in which the support member extends, a protrusion portion protruding outwardly to cover an upper surface of the support member may be disposed on the base portion, and a fastening portion into which the fastening mechanism is inserted may be disposed in the base portion and the protrusion portion.

According to various aspects of the present disclosure, the protrusion portion may be disposed at a point between adjacent fastening portions among fastening portions disposed in the base portion on the base portion.

According to various aspects of the present disclosure, the protrusion portion may be disposed at a point corresponding to a point at which the fastening portion is disposed on the base portion.

According to various aspects of the present disclosure, a plurality of protrusion portions may be disposed to be spaced apart from each other, and the fastening portion may be alternately disposed at a point corresponding to a point at which a first protrusion portion is disposed on the base portion and at a second protrusion portion adjacent to the first protrusion portion.

According to various aspects of the present disclosure, a plurality of protrusion portions may be disposed to be spaced apart from each other, and a protrusion portion in which the fastening portion is not disposed may be disposed between adjacent protrusion portions in which the fastening portion is disposed among the plurality of protrusion portions.

According to various aspects of the present disclosure, a plurality of protrusion portions may be disposed to be spaced apart from each other, and the fastening portion disposed in the base portion may be disposed at a point corresponding to a protrusion portion in which the fastening portion is not disposed among the plurality of protrusion portions.

According to various aspects of the present disclosure, a plurality of protrusion portions may be disposed to be spaced apart from each other, the fastening portion may be disposed in each of the protrusion portions, and the fastening portion disposed in the base portion may be disposed at a point corresponding to a position at which the protrusion portion is formed.

According to various aspects of the present disclosure, the fastening portion may be disposed on an alignment line disposed on the end plate to extend in a direction in which the support member extends.

According to various aspects of the present disclosure, a plurality of alignment lines may be disposed on the base portion or the protrusion portion, and the fastening portions respectively disposed on adjacent to alignment lines among the plurality of alignment lines may be alternately staggered with each other on the base portion or the protrusion portion.

According to various aspects of the present disclosure, a protrusion portion of a first end plate among the end plates may be disposed to alternately cross a protrusion portion of a second end plate disposed to be adjacent to the first end plate in a first direction in which the support member extends.

According to various aspects of the present disclosure, a protrusion portion of a first end plate among the end plates may be disposed so that an end portion thereof faces an end portion of a protrusion portion of a second end plate disposed to be adjacent to the first end plate in a second direction crossing a first direction in which the support member extends.

According to various aspects of the present disclosure, a fastening hole to which the fastening mechanism is coupled may be disposed in each of the end plate and the support member, and the fastening mechanism may include a bolt inserted into the fastening hole to couple the end plate and the support member by bolting.

According to various aspects of the present disclosure, a pop nut including a head portion disposed in a direction toward the end plate may be coupled to the fastening hole of the support member, and a lower surface of the end plate may be disposed at an upper end portion of the support member by being accommodated on the pop nut.

According to various aspects of the present disclosure, a load acting in a cell stacking direction may be uniformly distributed to stably maintain surface pressure between cells, an alignment state of the fastening portion may be maintained to suppress structural deformation or stress concentration, and fastening strength and support stability may be secured even during long-term use to improve durability and reliability of a battery module.

Effects that may be obtained from the present disclosure are not limited to the effects mentioned above, and other effects not mentioned may be clearly understood by those of ordinary skill in the art to which the present disclosure belongs from the description below.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a view showing a battery assembly of the present disclosure according to an exemplary embodiment of the present disclosure;

FIG. 2 is a view showing an upper surface of the battery assembly shown in FIG. 1;

FIG. 3 is a view showing a battery assembly of the present disclosure according to another exemplary embodiment of the present disclosure;

FIG. 4 is a view showing an upper surface of the battery assembly shown in FIG. 3;

FIG. 5 is a view showing a configuration of an end plate of the present disclosure;

FIG. 6 is a view showing a cross-section of the battery assembly of the present disclosure;

FIG. 7 is a view showing coupling between the end plate and a support member of the present disclosure;

FIG. 8 is a view showing a pop nut of the present disclosure;

FIG. 9 is a view showing an example of fastening portion arrangement of the present disclosure;

FIG. 10 is a view showing another example of fastening portion arrangement of the present disclosure;

FIG. 11 is a view showing yet another example of fastening portion arrangement of the present disclosure;

FIG. 12 is a view showing a modified example of fastening portion arrangement of the present disclosure;

FIG. 13 is a view showing another modified example of fastening portion arrangement of the present disclosure;

FIG. 14 is a view showing an example of fastening portion arrangement between adjacent end plates of the present disclosure; and

FIG. 15 is a view showing another example of fastening portion arrangement between adjacent end plates of the present disclosure.

### DETAILED DESCRIPTION

In describing the embodiments disclosed in the present specification, when it is determined that a detailed description of related known technologies may obscure the gist of the embodiments disclosed in the present specification, the detailed description thereof will be omitted. Furthermore, the accompanying drawings are only for easily understanding the embodiments disclosed in the present specification and are not intended to limit the technical idea disclosed in the present specification by the accompanying drawings, and should be understood to include all modifications, equivalents, and substitutes included in the spirit and technical scope of the present disclosure. The following disclosure is not intended to limit the present disclosure to the described form or specific field, and it is considered that various alternative aspects and modifications of the present disclosure are possible, whether explicitly described or implied in the present specification. Those of ordinary skill in the art to which the present disclosure belongs will recognize that the form and details of the present disclosure may be changed.

The present disclosure is described with reference to specific aspects. However, as understood by those of ordinary skill in the art to which the present disclosure belongs, various aspects disclosed in the present specification may be modified or otherwise implemented in various other ways without departing from the spirit and scope of the present disclosure. Therefore, the following description should be considered as illustrative and is for the purpose of teaching those of ordinary skill in the art to which the present disclosure belongs how to make and use various embodiments. It will be understood that the forms of the present disclosure shown and described in the present specification will be taken as representative embodiments. Equivalent elements, or materials, processes, or steps may be substituted for those representatively exemplified and described in the present disclosure. Expressions such as “including”, “comprising”, “incorporating”, “consisting of”, “have”, “is”, etc. used in describing the present disclosure should be interpreted in a non-exclusive manner, that is, to allow items, components, or elements not explicitly described to be indicated. In addition, references to the singular should be interpreted to include those related to the plural.

Furthermore, various embodiments disclosed in the present specification should be taken in an illustrative and descriptive sense and should not be interpreted as limiting the contents of the present disclosure. All references to joining (for example, attached, affixed, coupled, connected, etc.) are used only to aid in understanding the present disclosure and do not limit the position, orientation, or use of the configuration or the method disclosed in the present specification. Therefore, when joining references exist, they should be interpreted broadly. Moreover, in such joining references, it is not concluded that two or more elements are directly connected to each other. Additionally, all numerical terms, for example, “first”, “second”, “third”, “primary”, “secondary”, “main”, or any other general or numerical term, should be taken only as identifiers to assist in understanding the various components, forms, changes, or modifications of the present disclosure, and do not mean limitations to any component, form, change, or modification or to their order or preference. That is, these expressions may be used to describe various components, but the components are not limited by these expressions. These expressions are used only for the purpose of distinguishing one component from another component.

The suffixes “module” and “portion” for components used in the following description are given or mixed only considering the ease of writing the specification, and do not have distinct meanings or roles by themselves.

When it is mentioned that a component is “connected” or “coupled” to another component, it should be understood that the component may be directly connected or coupled to the other component, but other components may exist in between. On the other hand, when it is mentioned that a component is “directly connected” or “directly coupled” to another component, it should be understood that no other component exists in between.

Furthermore, the unit or control unit included in the name is only a term widely used for naming a controller that is configured to control a vehicle-specific function, and does not mean a generic function unit.

A controller may include a communication device that communicates with other controllers or sensors for control of a function in charge, a memory that stores an operating system, logic commands, input/output information, etc., and one or more processors that perform judgment, calculation, determination, etc. necessary for control of the function in charge.

Any number of components or various components in any of the configurations described in the present specification may be included in the present disclosure described in the present specification. The components may include any combination of the features described in the present specification and may be disposed in any of the various configurations described in the present specification. Concepts regarding the structure and arrangement of the components of the present disclosure as well as their use and operation may be applied to any number of embodiments in any combination as well as to the specific embodiments discussed in the present specification. Embodiments including those having various features of various arrangements are described below with reference to the drawings.

Hereinafter, various embodiments disclosed in the present specification will be described in detail with reference to the accompanying drawings, and the same or similar components will be assigned the same reference numerals regardless of drawing symbols, and redundant descriptions thereof will be omitted.

The present disclosure is provided to prevent reliability degradation due to load imbalance and structural deformation occurring in a battery cell stacking structure, and presents a battery assembly configured for securing mechanical strength and assembly precision while stably maintaining a pressurized state of a cell.

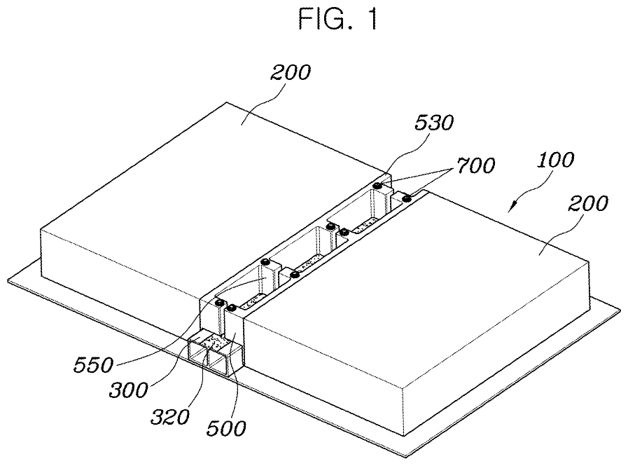

First, a battery assembly of the present disclosure will be described with reference to FIG. 1.

FIG. 1 is a view showing a battery assembly of the present disclosure according to an exemplary embodiment of the present disclosure.

The battery assembly of the present disclosure may include a battery case 100, a battery cell array 200, a support member 300, an end plate 500, and a fastening mechanism 700.

First, the battery case 100 forms an internal space in which a plurality of battery cells 220 are stacked and disposed, and may include a structure in which an upper case 120 and a lower case 140 are coupled. The battery case 100 protects the entire battery cell array 200 from an external environment and may mitigate transmission of vibration or impact. Furthermore, the battery case 100 may secure rigidity of the entire module through coupling with the support member 300 and the end plate 500 disposed therein.

The battery case 100 has a constant thickness so that thermal deformation or stress concentration does not occur, and may be precisely disposed along an external peripheral surface of the battery cell array 200. A coupling portion to which the support member 300 may be connected is disposed at an internal side of the case 100, and alignment during an assembly process may be secured. Through the present configuration, the case 100 may minimize a position error that may occur upon fastening the support member 300 and may enable stable surface pressure transmission upon mounting of the fastening mechanism 700.

The battery cell array 200 may include a structure in which a plurality of battery cells 220 are stacked in a predetermined direction in a state of being in close contact with each other. Each battery cell 220 is disposed to fit an internal space of the battery case 100 and may be accommodated at one side of the support member 300. At the instant time, the battery cell array 200 is pressurized from an external side by the end plate 500 to maintain a constant pressure, and a shape and position of the entire cells may be stably maintained.

The battery cell array 200 may be configured with various types of cells 220. For example, the battery cell array 200 may include a pouch-type cell, a prismatic cell, or a cylindrical cell. In a case of using a pouch-type cell, a cushioning sheet may be attached to an edge portion of each cell 220, so that a spacing between cells may be constantly maintained. In a case of a prismatic cell, a cell housing itself may provide structural support, and as needed, an insulating pad may be located between cells to maintain a balance of heat transfer together with electrical insulation.

The battery cell array 200 may be configured to apply a constant pressure in advance during an assembly process so that the cells 220 do not shake. For the present purpose, a cushioning member of an elastic material may be disposed at both end portions of a cell stacking portion, and the cushioning member may reduce a shape change even during long-term use to maintain uniformity of pressure.

Furthermore, assembly may proceed with a structure in which the entire cell stacking portion is temporarily fixed using a strap or a bracket, and the strap may be removed after the end plate 500 is connected.

Through such a structure, even when vibration or impact is transmitted from outside to the battery cell array 200, each cell 220 may share a uniform load. Furthermore, even when minute expansion or contraction of the cell 220 occurs, a spacing with an adjacent cell may be constantly maintained, thereby improving mechanical stability of the entire module.

Next, the support member 300 will be described.

The support member 300 is a structural body disposed in an interior of the battery case 100 and extending along a longitudinal direction of the battery cell array 200, and may support the battery cell array 200 while receiving a pressurizing load transmitted from the end plate 500 as a reaction force.

The support member 300 may be disposed to support the battery cell array 200 in the same direction as a pressurizing direction in which the end plate 500 acts from an external side of the battery cell array 200. Accordingly, the support member 300 may form a load transmission path so that a uniform surface pressure may be applied to the entire battery cell array 200.

The support member 300 includes a flat support surface at an upper end portion thereof, and the present support surface may be used as a reference surface on which a lower end portion of the end plate 500 is accommodated.

The support member 300 may include a center portion 320 extending along a longitudinal direction thereof. The center portion 320 is a structural reference portion disposed at a center portion of a width direction of the support member 300, and may mean a reference region that uniformly distributes a load applied from the end plate 500 and the fastening mechanism 700.

Furthermore, the center portion 320 supports the battery cell array 200 so that a load thereof is not locally concentrated, and may maintain rigidity of the entire support member 300. Accordingly, the center portion 320 may function as a load distribution path that suppresses deformation of the end plate 500 inside the battery case 100.

The support member 300 may be coupled to the base portion 530 and the protrusion portion 550 of the end plate 500 and connected in a vertical direction. The base portion 530 is in close contact with a side surface of the support member 300 and transmits a pressurizing force toward the battery cell array 200, and the protrusion portion 550 is disposed to cover an upper end portion of the support member 300 and may act to distribute a fulcrum upon rotational deformation of the end plate 500.

At the present time, the support member 300 may receive tensile force and compressive force occurring between the base portion 530 and the protrusion portion 550 together, thereby suppressing occurrence of bending of the end plate 500.

The support member 300 may securely support the battery cell array 200, uniformly distribute a load transmitted from the end plate 500, and secure fastening stability with the end plate 500 through the fastening mechanism 700. Furthermore, the support member 300 may mitigate stress concentration due to bending of the end plate 500 to prevent damage to the fastening mechanism 700, and may stably maintain surface pressure of the battery cell array 200 for a long period.

Next, the end plate 500 will be described.

The end plate 500 is a member that pressurizes the battery cell array 200 from an external side of the battery cell array 200, and may be disposed at a position facing the support member 300 inside the battery case 100. The end plate 500 is a component for uniformly transmitting surface pressure to the entire external peripheral surface of the battery cell array 200, and may maintain a constant pressurized state while responding to expansion or contraction of the battery cell array 200.

The end plate 500 may include a base portion 530 including an overall flat plate shape, and a protrusion portion 550 protruding outwardly from an upper portion of the base portion 530 and covering an upper surface of the support member 300.

The base portion 530 is a surface that directly abuts against an external side surface of the battery cell array 200, and may enable a pressurizing force of the end plate 500 to uniformly act on the battery cell array 200.

Meanwhile, the protrusion portion 550 extends above an upper portion of the support member 300 and may perform a structural role of distributing a rotation center portion of the end plate 500. According to such an arrangement, the end plate 500 may include an L-shaped cross-section, and thereby an upper load may be distributed and bending deformation may be suppressed.

A fastening portion 570 into which the fastening mechanism 700 is inserted may be disposed in the base portion 530 and the protrusion portion 550 of the end plate 500. The fastening portion 570 may pass through an upper portion of the base portion 530 or a partial section of the protrusion portion 550 and be connected to the upper surface of the support member 300, and as a result, the end plate 500 may be fixed to the support member 300 in a vertical direction.

Through such a structure, a local bending load occurring upon tightening of the fastening mechanism 700 is distributed to the protrusion portion 550 and the base portion 530, so that bending of the end plate 500 may be minimized.

The end plate 500 may be disposed over the entire longitudinal direction of the battery cell array 200, and each fastening portion 570 may be disposed at regular intervals along alignment lines L1 and L2 to be described later.

Furthermore, a lower portion of the end plate 500 abuts against a side surface of the support member 300, and may suppress rotational deformation that may occur in a fastened state.

The end plate 500 may be disposed of various materials considering structural strength and durability. For example, the end plate 500 may be manufactured using aluminum alloy, high-tensile steel, or composite material, and a local reinforcing rib may be added to suppress deformation due to external force. As needed, an insulating coating or an anti-corrosion treatment layer may be disposed on a surface of the end plate 500 to secure electrical insulation and corrosion resistance.

The end plate 500 may uniformly maintain surface pressure acting on the battery cell array 200, suppress bending deformation through coupling with the support member 300, and efficiently distribute a load of the fastening mechanism 700. Furthermore, such structural coupling may minimize surface pressure imbalance due to expansion of the battery cell array 200 even during long-term operation, and may maintain mechanical stability of the entire battery assembly.

Next, the fastening mechanism 700 will be described.

The fastening mechanism 700 is a configuration for fixing the end plate 500 and the support member 300 in a vertical direction, and may perform a role of stably maintaining a stacked state of the battery cell array 200.

The fastening mechanism 700 may include a structure in which the fastening mechanism 700 passes through the fastening portion 570 of the end plate 500, is inserted into a fastening hole of the support member 300, and then is coupled to a pop nut 900. Through the present configuration, the fastening mechanism 700 may enable the end plate 500 to press the battery cell array 200 in a pressurized state, and may simultaneously suppress deformation of the end plate 500.

The fastening mechanism 700 may generally be configured in a bolt form, and a lower end portion of the bolt may be inserted into the fastening hole of the support member 300 and connected to the pop nut 900. At the instant time, a head portion 920 of the pop nut 900 is disposed to face the end plate 500, so that a lower surface of the end plate 500 may be directly accommodated on the pop nut 900. Such a structure may prevent deformation of the pop nut 900 upon application of fastening torque, absorb a height deviation between the support member 300 and the end plate 500, and minimize assembly error.

Furthermore, since the pop nut 900 acts as a load distribution portion, tensile load applied to the fastening mechanism 700 may be uniformly distributed.

The fastening mechanism 700 may be disposed at positions corresponding to the base portion 530 and the protrusion portion 550 of the end plate 500, respectively.

For example, a base portion fastening mechanism 710 inserted into a fastening portion 571 disposed in the base portion 530 and a protrusion portion fastening mechanism 730 inserted into a fastening portion 572 disposed in the protrusion portion 550 may be respectively disposed. Through such a multi-fastening structure, the fastening mechanism 700 may prevent a rotation center portion of the end plate 500 from being disposed on a single line, and may distribute a fastening load acting in a vertical direction.

That is, the base portion fastening mechanism 710 is in charge of surface pressure that directly pressurizes the battery cell array 200, and the protrusion portion fastening mechanism 730 may fix a position of the protrusion portion 550 covering an upper end portion of the support member 300 to suppress bending deformation of the end plate 500.

Therefore, the fastening mechanism 700 may increase coupling force between the end plate 500 and the support member 300, and may simultaneously perform a role of suppressing deformation or stress concentration of the end plate 500.

The fastening mechanism 700 may be disposed in various embodiments considering convenience of assembly and maintenance. For example, in addition to a general bolt-nut coupling structure, a cap bolt structure that facilitates torque management or a snap-fixed fastening structure for preventing separation after fastening may be applied. As needed, a washer or an insulating member may be located between the fastening mechanism 700 and the end plate 500 to simultaneously achieve electrical insulation and vibration mitigation.

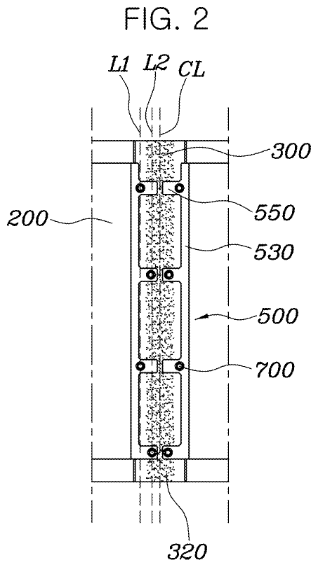

Next, an arrangement of the battery assembly of the present disclosure will be described in more detail with reference to FIG. 2.

FIG. 2 is a view showing an upper surface of the battery assembly shown in FIG. 1.

Referring to FIG. 2, the battery cell array 200, the support member 300, the end plate 500, and the fastening mechanism 700 are disposed along a longitudinal direction thereof, and the end plate 500 and the support member 300 may be coupled in a vertical direction through the fastening portion 570 of the fastening mechanism 700.

The end plate 500 extends along a longitudinal direction along an external side surface of the battery cell array 200, and may include the base portion 530 and the protrusion portion 550. The base portion 530 is disposed as a portion that is in contact with a side surface of the battery cell array 200 and transmits surface pressure, and the protrusion portion 550 may be configured in a shape that protrudes outwardly from an upper end portion of the base portion 530 and covers an upper surface of the support member 300.

Such a shape of the end plate 500 may separate a position of the fastening portion 570 into the base portion 530 and the protrusion portion 550, so that a load occurring upon fastening is not concentrated on one side but is evenly distributed.

The fastening mechanism 700 may pass through the fastening portion 570 of the end plate 500 and be inserted into the support member 300. As shown in FIG. 2, the fastening portion 570 is disposed along the longitudinal direction of the end plate 500 based on the alignment lines L1 and L2, and each alignment line may be disposed to correspond to the base portion 530 and the protrusion portion 550, respectively.

The alignment line L1 and the alignment line L2 are disposed parallel to each other, and positions of the fastening portion 570 may be alternately staggered. Such an arrangement may cause the fastening mechanism 700 to be coupled in different directions at the end plate 500, thereby mitigating stress concentration that may occur on the same axis and distributing a fastening load.

The fastening mechanism 700 disposed on the alignment line L1 may transmit surface pressure toward the battery cell array 200 through the base portion 530, and the fastening mechanism 700 disposed on the alignment line L2 may act in a direction of covering the upper surface of the support member 300 through the protrusion portion 550.

Through the present configuration, the fastening mechanism 700 may suppress deformation of the end plate 500 and prevent displacement or torsion between fastening positions. Furthermore, each fastening mechanism 700 may be coupled to the support member 300 via the pop nut 900, and a head portion of the pop nut 900 may be disposed to support the lower surface of the end plate 500.

Such a structure may reduce a fastening height deviation upon fastening, and may enable the end plate 500 and the support member 300 to maintain a parallel state upon application of fastening torque.

According to the configuration shown in FIG. 2, the fastening portion 570 is alternately disposed along the alignment lines L1 and L2, so that a fastening position of the fastening mechanism 700 is disposed in a staggered manner, and thereby a fastening load may be evenly distributed over the entire end plate 500.

Such a multi-fastening structure may prevent a rotation center portion of the end plate 500 from being disposed on a single line, and may mitigate stress concentration between fastening positions to improve structural stability of the battery assembly.

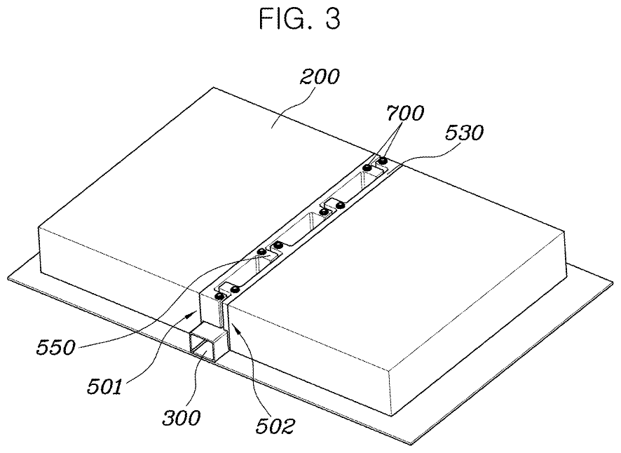

Next, an exemplary embodiment in which the protrusion portions 550 of the end plate 500 are disposed to be alternately disposed will be described with reference to FIG. 3.

FIG. 3 is a view showing a battery assembly of the present disclosure according to another exemplary embodiment of the present disclosure.

As shown in FIG. 3, a plurality of end plates 500 are disposed to be adjacent to each other, and may be configured in a form in which the protrusion portion 550 of each end plate 500 is alternately disposed.

For example, the end plate 500 may include a first end plate 501 and a second end plate 502. The first end plate 501 and the second end plate 502 respectively extend along a longitudinal direction along an external side surface of the battery cell array 200, and may be connected to an upper surface of the support member 300.

Each of the end plates 501 and 502 includes the base portion 530 and the protrusion portion 550, and the protrusion portion 550 may be disposed in a direction of covering the upper surface of the support member 300. At the instant time, the protrusion portion 550 of the first end plate 501 and the protrusion portion 550 of the second end plate 502 are alternately disposed to form a zig-zag pattern arrangement, and such an arrangement may be disposed to cross along the upper surface of the support member 300.

That is, at a portion where the protrusion portion 550 of the first end plate 501 covers the upper surface of the support member 300, the protrusion portion 550 of the second end plate 502 is disposed to avoid the upper surface of an adjacent region, so that the protrusion portions 550 may be disposed so as not to interlock with each other along a longitudinal direction of the support member 300.

Such a crossed arrangement may mitigate stress concentration that may occur at a boundary portion between adjacent end plates 500. Through the present configuration, a fastening load applied by the fastening mechanism 700 is constantly distributed, and a phenomenon in which an upper portion of the support member 300 is locally pressed or lifted may be prevented.

Furthermore, such an alternate arrangement of the protrusion portions 550 may increase resistance of the end plate 500 to thermal deformation or vibration. As each protrusion portion 550 alternately covers the upper surface of the support member 300, when a minute length change occurring upon thermal expansion is transmitted to an adjacent end plate 500, collision or interference may be mitigated.

Therefore, an arrangement structure according to the exemplary embodiment of the present disclosure may maintain fastening stability of the end plate 500 in a temperature change environment, and a load distribution for each fastening position may become more uniform.

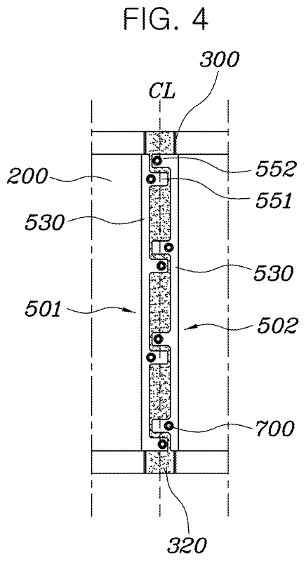

Subsequently, the exemplary embodiment of FIG. 3 will be described in more detail with reference to FIG. 4.

FIG. 4 is a view showing an upper surface of the battery assembly shown in FIG. 3.

Referring to FIG. 4, the first end plate 501 and the second end plate 502 are disposed along the upper surface of the support member 300, and a configuration in which the base portion 530 and the protrusion portions 551 and 552 of each end plate 500 are alternately disposed may be confirmed.

The protrusion portion 551 of the first end plate 501 is disposed at a left side based on a center line CL of the support member 300, and the protrusion portion 552 of the second end plate 502 may be disposed at a right side based on the center line CL.

As the protrusion portions 551 and 552 are alternately disposed with respect to the center line in the present manner, the upper surface of the support member 300 is covered in a divided form to left and right. Therefore, a load applied by the fastening mechanism 700 is not concentrated along the center line, but is distributed to both sides, so that structural balance may be maintained. The protrusion portions 551 and 552 may be disposed to cover a center portion of the support member 300, and at the instant time, the center portion of the support member 300 may mean a predetermined region disposed along a longitudinal direction of the support member 300 based on the center line CL.

Furthermore, each of the end plates 501 and 502 is coupled to the support member 300 through the fastening portion 570 of the fastening mechanism 700, and the fastening portion 570 may be alternately disposed in the base portion 530 and the protrusion portions 551 and 552 of the end plate 500.

A fastening position structure crossed based on the center line CL may prevent a rotation center portion of the end plate 500 from being disposed on a single axis, and may secure overall fastening stability by maintaining an interval between fastening portions constant.

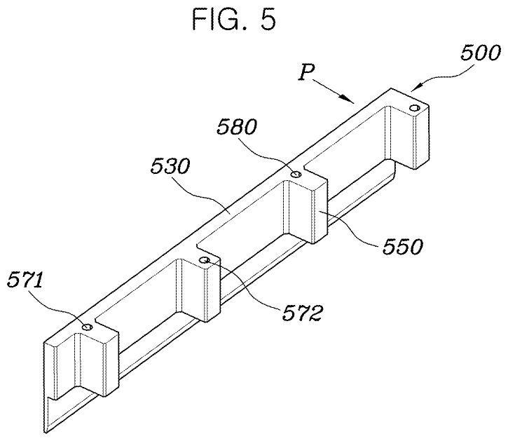

Next, a configuration of the end plate 500 will be described in detail with reference to FIG. 5.

FIG. 5 is a view showing a configuration of an end plate of the present disclosure.

Referring to FIG. 5, the end plate 500 includes the base portion 530 and the protrusion portion 550, and a plurality of fastening portions 570 into which the fastening mechanism 700 is inserted may be disposed in the base portion 530 and the protrusion portion 550.

The base portion 530 is a flat portion that is in contact with an external side surface of the battery cell array 200, and may perform a role of directly receiving surface pressure P transmitted from a cell and structurally distributing the surface pressure P.

The protrusion portion 550 is disposed in a shape protruding outwardly from an upper end portion of the base portion 530, and may extend in a direction of covering the upper surface of the support member 300. Through the present configuration, the end plate 500 may comprehensively support a boundary region between the battery cell array 200 and the support member 300, thereby suppressing a bending or lifting phenomenon due to the surface pressure P.

Furthermore, the fastening portion 570 of the end plate 500 may be selectively disposed in the base portion 530 or the protrusion portion 550. For example, a first fastening portion 571 may be disposed in the base portion 530 of the end plate 500, and a second fastening portion 572 may be disposed in the protrusion portion 550.

The first fastening portion 571 and the second fastening portion 572 are disposed at different points, and the first fastening portion 571 and the second fastening portion 572 may be alternately disposed along a longitudinal direction of the end plate 500. Such an alternate arrangement structure may prevent a load from being concentrated along a specific line upon fastening, and may cause the load to be evenly distributed over the entire end plate 500.

Furthermore, as shown in FIG. 5, the surface pressure P is transmitted from the battery cell array 200 to the end plate 500, and may be distributed to the fastening portion 570 of the fastening mechanism 700 along the base portion 530.

At the present time, the protrusion portion 550 may auxiliary support an axial load on which the fastening mechanism 700 acts by covering the upper surface of the support member 300, and may provide a structural reinforcement effect of suppressing bending deformation together with the base portion 530.

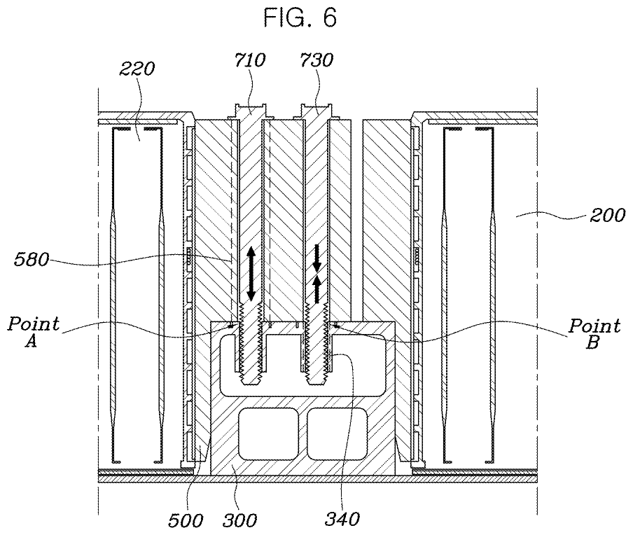

Hereinafter, an operation of the fastening mechanism 700 will be described with reference to FIG. 6.

FIG. 6 is a view showing a cross-section of the battery assembly of the present disclosure.

Referring to FIG. 6, the fastening mechanism 700 may include a fastening mechanism 710 inserted into a base portion fastening portion and a fastening mechanism 730 inserted into a protrusion portion fastening portion. These two fastening mechanisms are inserted and connected at different positions of the end plate 500, and may be configured so that a fastening force and a reaction force are uniformly distributed throughout the structure.

In a case where a bending force occurs in the end plate 500 due to swelling of the battery cell 220, tensile force occurs in the fastening mechanism 710 connected at a side close to the battery cell 220 in which swelling has occurred, and compressive force may act on the fastening mechanism 730 coupled at a side far from the battery cell 220 in which swelling has occurred. Through the present configuration, a bending phenomenon of the end plate 500 may be prevented, and the end plate 500 may expand evenly. First, the fastening mechanism 710 may be disposed in a form of passing through the base portion 530 of the end plate 500 and being coupled to the support member 300. The present fastening mechanism 710 may stably transmit surface pressure acting on the battery cell array 200 by bringing the end plate 500 into close contact with the support member 300 upon fastening. Accordingly, the end plate 500 may provide a constant reaction force in response to an expansion force of the battery cell 220 at a region in contact with the base portion 530, that is, near Point A.

On the other hand, the fastening mechanism 730 may pass through the protrusion portion 550 of the end plate 500 and be connected from an upper side thereof. The present fastening mechanism 730 fixes the protrusion portion 550 to maintain a structural form of covering an upper surface of the support member 300, and may distribute a fastening load to an upper end portion of the support member 300. At the instant time, a fastening force in a Point B region is transmitted to the support member 300 through the protrusion portion 550, and a corresponding reaction force may be transmitted back to the battery cell array 200 through the end plate 500. Therefore, Point A and Point B may function as load balance points at which a fastening force and a reaction force of the fastening mechanism 700 correspond to and act on each other.

Furthermore, the fastening structure shown in FIG. 6 may be designed so that the fastening mechanisms 710 and 730 are inserted into the fastening portions 570 disposed in a crossed manner in left and right directions, so that a fastening line is not disposed on the same axis. Such a structure may prevent a load from being concentrated at a specific position upon fastening, and may cause the load to be uniformly distributed over the entire end plate 500.

The support member 300 is configured to receive a reaction force of a fastening force while suppressing deformation, and may provide a stable support state on an external side surface of the battery cell array 200 together with the end plate 500.

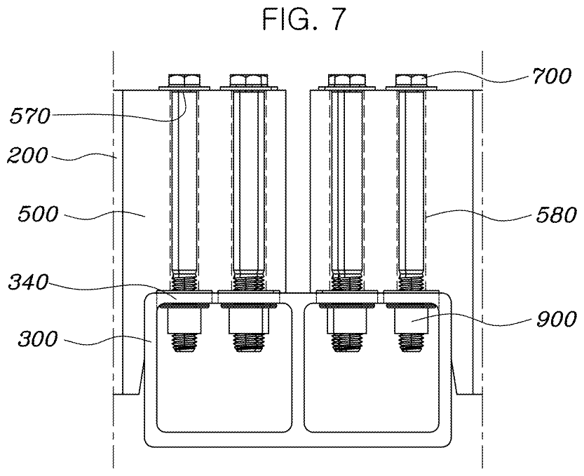

Hereinafter, fastening of the fastening mechanism 700 will be described with reference to FIG. 7.

FIG. 7 is a view showing coupling between the end plate and a support member of the present disclosure.

The fastening mechanism 700 may include a structure in which the fastening mechanism 700 passes through the fastening portion 570 of the end plate 500 and is coupled to the support member 300.

For example, the fastening mechanism 700 may be implemented as a bolt, a nut, or a similar fastener, and may stably pressurize a side surface of the battery cell array 200 by integrally fixing the end plate 500 and the support member 300 upon fastening.

Furthermore, as shown in FIG. 7, the pop nut 900 may be coupled to a lower end portion of the fastening mechanism 700. The pop nut 900 is inserted into a fastening portion of the support member 300 and may maintain a constant fastening depth upon tightening of the fastening mechanism 700, and may absorb a deviation of fastening force to provide structural flatness. Furthermore, the pop nut 900 may prevent direct metal-to-metal contact between the support member 300 and the fastening mechanism 700, thereby suppressing wear or loosening due to repeated fastening.

During a fastening process, the fastening mechanism 700 moves downwardly along the fastening portion 570 of the end plate 500, and a load occurring at the instant time may be transmitted to the battery cell array 200 through the end plate 500. The support member 300 may receive a reaction force of the present fastening load and perform a role of suppressing deformation together with the end plate 500. Therefore, as the fastening mechanism 700, the end plate 500, and the support member 300 are mutually connected, the external side surface of the battery cell array 200 may be maintained in a uniform surface pressure state.

Furthermore, the fastening portion 570 of the end plate 500 is designed to be matched with a diameter of the fastening mechanism 700, so that shaking or eccentricity may not occur upon fastening.

Meanwhile, a fastening path 580 through which the fastening mechanism 700 is inserted may be formed in the end plate 500 and/or the support member 300. The fastening path 580 may be aligned with the fastening portion 570 and guide insertion of the fastening mechanism 700 in a vertical direction.

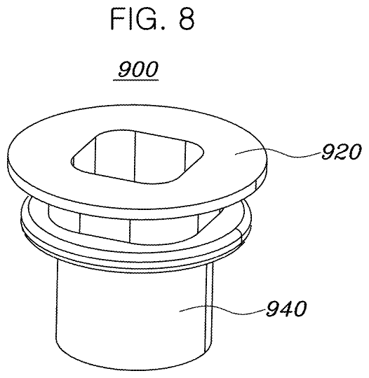

Next, a pop nut 900 that may be used in an exemplary embodiment of the present disclosure will be described with reference to FIG. 8.

FIG. 8 is a view showing a pop nut of the present disclosure.

The pop nut 900 is disposed on a fastening portion of the support member 300 into which the fastening mechanism 700 is inserted, and may be used as a configuration for absorbing a deviation of fastening force and securing fastening stability.

For example, the pop nut 900 may include an upper head portion 920 and a lower body portion 940. The head portion 920 is in close contact with a surface of the support member 300 and provides a reaction force corresponding to a tightening force of the fastening mechanism 700, and the body portion 940 may be fitted into an interior of the support member 300 to maintain a position.

At the present time, an external diameter of the head portion 920 is greater than a fastening hole 340 of the support member 300, and an external diameter of the body portion 940 is disposed to be matched with the fastening hole 340, so that the pop nut 900 may be stably fixed upon assembly.

As the fastening mechanism 700 moves downwardly during a fastening process, the pop nut 900 may be deformed inside the support member 300 and expansion-coupled. Accordingly, when the fastening mechanism 700 is completely tightened, the pop nut 900 may be fixed in an integrated state with the support member 300, and loosening or separation may not occur even with a change in fastening force thereafter.

Furthermore, through such a structure, a rotation force of the fastening mechanism 700 may be distributed by the pop nut 900, thereby suppressing accumulation of metal fatigue or occurrence of cracks in the support member 300. For example, the pop nut 900 may be disposed of a metal material such as aluminum alloy, brass, stainless steel, etc., and insulating coating or anti-corrosion treatment may be applied as needed.

Furthermore, a thread matched with an external diameter of the fastening mechanism 700 is disposed on an internal diameter of the pop nut 900, so that a safe fastening force may be secured. Accordingly, the pop nut 900 may maintain a constant fastening force with the fastening mechanism 700.

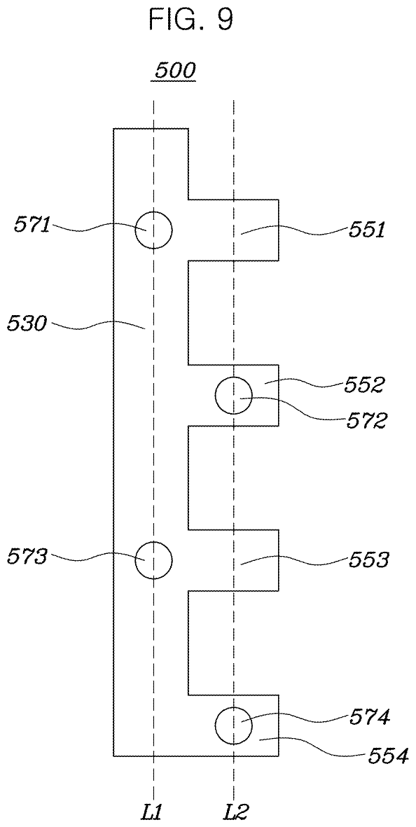

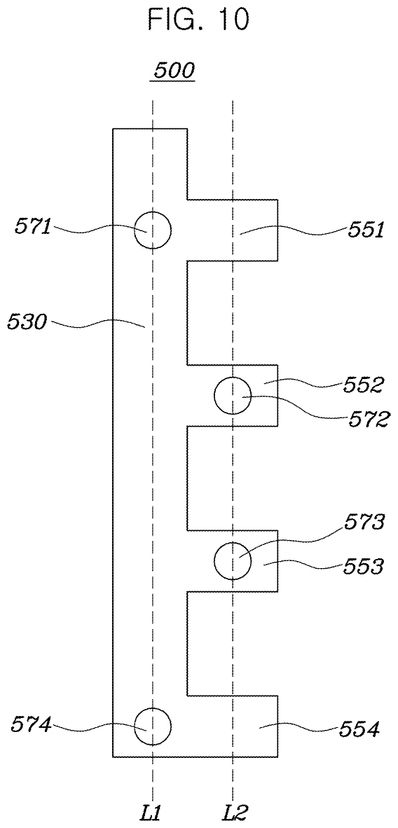

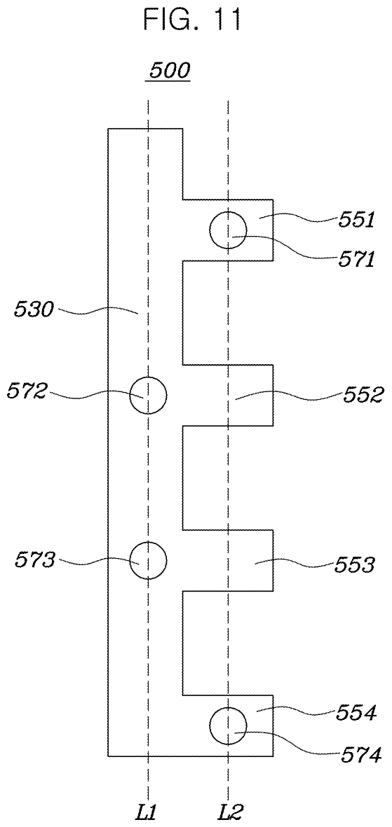

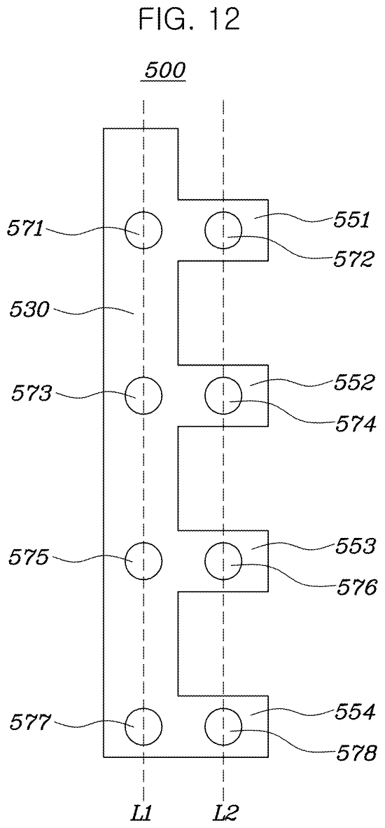

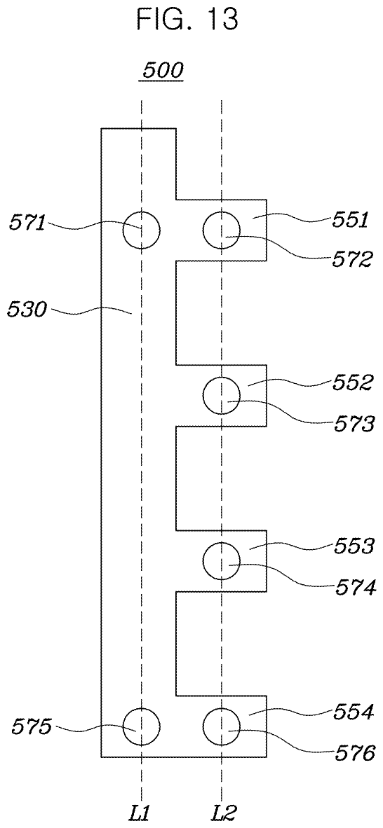

Hereinafter, an arrangement of the fastening portion 570 of the end plate 500 will be described with reference to FIG. 9, FIG. 10, FIG. 11, FIG. 12, and FIG. 13.

FIG. 9 is a view showing an example of fastening portion arrangement of the present disclosure, FIG. 10 is a view showing another example of fastening portion arrangement of the present disclosure, FIG. 11 is a view showing yet another example of fastening portion arrangement of the present disclosure, FIG. 12 is a view showing a modified example of fastening portion arrangement of the present disclosure, and FIG. 13 is a view showing another modified example of fastening portion arrangement of the present disclosure.

FIG. 9 may be a view showing a structure in which fastening portions are alternately disposed in a protrusion portion and a base portion as an exemplary embodiment of the end plate 500.

The end plate 500 may include a base portion 530 disposed long along a direction in which a support member extends, and a plurality of protrusion portions 551, 552, 553, and 554 protruding outwardly from the base portion 530. Each of the protrusion portions 551, 552, 553, and 554 is disposed to be spaced apart from each other at a predetermined interval, and the end plate 500 may form an overall sawtooth-shaped outline as these protrusion portions are alternately disposed.

Fastening portions 571, 572, 573, and 574 into which the fastening mechanism 700 is inserted may be disposed in some of the base portion 530 and the protrusion portions 551, 552, 553 and 554.

For example, as shown in FIG. 9, a fastening portion is not disposed in the first protrusion portion 551, and a first fastening portion 571 may be disposed at a position of the base portion 530 corresponding thereto. On the other hand, a second fastening portion 572 may be disposed in the second protrusion portion 552. Subsequently, a fastening portion is not disposed in the third protrusion portion 553, and a third fastening portion 573 may be disposed at a position of the base portion 530 corresponding thereto. Finally, a fourth fastening portion 574 is disposed in the fourth protrusion portion 554, and the fastening mechanism 700 may be inserted.

Accordingly, the fastening portions 571, 572, 573, and 574 are alternately disposed on the protrusion portions 551, 552, 553, and 554 and the base portion 530, and may be disposed alternately in left and right directions while maintaining a predetermined interval along a longitudinal direction of the end plate 500. Such an arrangement may cause a fastening load not to be biased to one side and to be evenly distributed over the entire end plate 500, and may enable the end plate 500 to be uniformly in close contact with a support member upon assembly.

Furthermore, since the alternately disposed fastening portions 571, 572, 573, and 574 have each fastening position clearly distinguished, mis-insertion in an assembly process may be prevented, and a line into which the fastening mechanism 700 is inserted may be guided to be aligned along a longitudinal direction of the end plate 500.

FIG. 10 may be a view showing a structure in which fastening portions 572 and 573 are disposed in some protrusion portions 552 and 553, and fastening portions are not disposed in adjacent protrusion portions 551 and 554, and fastening portions 571 and 574 are disposed on the base portion 530 corresponding thereto, as another exemplary embodiment of the end plate 500.

As shown in FIG. 10, a fastening portion is not disposed in the first protrusion portion 551, and a first fastening portion 571 may be disposed at a position of the base portion 530 corresponding thereto. Subsequently, a second fastening portion 572 may be disposed in the second protrusion portion 552. The third protrusion portion 553 therebelow may also include a fastening portion 573, and a third fastening portion 573 may be disposed at the present position. Finally, the fourth protrusion portion 554 does not include a fastening portion formed, and a fourth fastening portion 574 may be disposed on the base portion 530 corresponding thereto.

According to such a structure, the protrusion portions 551, 552, 553, and 554 are disposed as a plurality spaced apart from each other, and between protrusion portions in which a fastening portion is not disposed (for example, the first protrusion portion 551 or the fourth protrusion portion 554), there may be adjacent protrusion portions in which a fastening portion is disposed (for example, the second protrusion portion 552 and the third protrusion portion 553). That is, an arrangement of fastening portions are not uniformly applied to all protrusion portions, and as the arrangement is alternately made between protrusion portions, fastening intervals are diversified and load distribution may be made more evenly.

Furthermore, the fastening portions 571 and 574 on the base portion 530 and the fastening portions 572 and 573 on the protrusion portions 552 and 553 may be alternately disposed while maintaining a predetermined interval along a longitudinal direction of the end plate 500. Such an arrangement of the fastening portion 570 may improve structural stability by causing an entire fastening load not to be locally concentrated when the end plate 500 is coupled to the support member 300, but to be evenly distributed along the protrusion portion 550 and the base portion 530.

FIG. 11 shows a fastening portion arrangement form opposite to FIG. 10 as another example of the end plate 500. That is, an arrangement of the fastening portions 571, 572, 573 and 574 disposed on the protrusion portions 551, 552, 553 and 554 and the base portion 530 is mutually alternately made, and may be a structure in which a fastening portion is disposed at a position where a fastening portion was not disposed in FIG. 10.

As shown in FIG. 11, a first fastening portion 571 may be disposed in the first protrusion portion 551. Subsequently, a fastening portion is not disposed in the second protrusion portion 552, and a second fastening portion 572 may be disposed on the base portion 530 corresponding thereto. Furthermore, a fastening portion is also not disposed in the third protrusion portion 553, and a third fastening portion 573 may be disposed at a position of the base portion 530 corresponding thereto. Finally, a fourth fastening portion 574 is disposed in the fourth protrusion portion 554, and a fastening mechanism may be coupled at a lower portion of the end plate 500.

In such a structure, the fastening portions 571, 572, 573 and 574 are alternately disposed on the protrusion portions 551, 552, 553 and 554 and the base portion 530, and overall include an arrangement form of being disposed in an alternating manner while maintaining a predetermined interval. Therefore, as the fastening portion 570 is alternately disposed in left and right directions along a longitudinal direction of the end plate 500, a fastening load may be evenly distributed over the entire end plate 500.

Such an arrangement method may secure design diversity through an opposite pattern fastening arrangement while preventing load concentration as in FIG. 10. For example, even within the same end plate shape, by selectively or combinedly applying the configurations of FIG. 10, and FIG. 11 according to a fastening direction or assembly conditions, assembly stability may be improved or structural rigidity may be adjusted.

FIG. 12 shows a structure in which fastening portions 571 to 578 are disposed on a plurality of alignment lines, and fastening portions on adjacent to alignment lines are alternately staggered with each other, as another example of the end plate 500.

As shown in FIG. 12, a first protrusion portion 551, a second protrusion portion 552, a third protrusion portion 553, and a fourth protrusion portion 554 protruding outwardly from the base portion 530 may be disposed to be spaced apart from each other. Fastening portions 572, 574, 576, and 578 may be disposed in each of the protrusion portions 551, 552, 553 and 554, and fastening portions 571, 573, 575, and 577 may likewise be disposed on the base portion 530 corresponding to each of the protrusion portions 551, 552, 553 and 554.

At the present time, the fastening portions 571, 573, 575, and 577 disposed on the base portion 530 are disposed on a first alignment line L1, and the fastening portions 572, 574, 576, and 578 disposed in each of the protrusion portions 551, 552, 553 and 554 may be disposed on a second alignment line L2. The two alignment lines L1 and L2 are disposed parallel to each other along a longitudinal direction of the end plate 500, and the fastening portions 570 disposed on each of the lines L1 and L2 may be disposed in an alternately staggered manner.

According to a structure in which the fastening portions 570 are alternately disposed in the present manner, a load acting on the end plate 500 upon fastening may be more evenly distributed, and structural torsion or uneven load may be minimized.

Furthermore, as the two alignment lines L1 and L2 are formed, the fastening mechanism 700 may be more evenly distributed over the entire base portion 530, and coupling strength between the end plate 500 and the support member 300 may be improved. As the fastening portion 570 is disposed in each of the protrusion portions 551, 552, 553 and 554 and the base portion 530, the end plate 500 may be fixed to the support member 300 in a multi-point fastening manner, so that deformation due to external force such as vibration or thermal expansion may be prevented.

FIG. 13 shows a multi-alignment structure in which fastening portions 571, 572, 573, 574, 575 and 576 are disposed on a plurality of alignment lines L1 and L2, and the fastening portions 571, 572, 573, 574, 575 and 576 on each of the alignment lines L1 and L2 are disposed at different positions, as another example of the end plate 500.

As shown in FIG. 13, the end plate 500 may include the base portion 530 and a plurality of protrusion portions 551, 552, 553 and 554 protruding outwardly from the base portion 530 disposed to be spaced apart from each other. One or more fastening portions 571, 572, 573, 574, 575 and 576 may be disposed in each of the protrusion portions 551, 552, 553 and 554, and one or more fastening portions 571 and 575 may be disposed in the base portion 530.

For example, a first fastening portion 571 may be disposed on the base portion 530 corresponding to the first protrusion portion 551, a second fastening portion 572 may be disposed in the first protrusion portion 551, a third fastening portion 573 may be disposed in the second protrusion portion 552, a fourth fastening portion 574 may be disposed in the third protrusion portion 553, and a fifth fastening portion 575 may be disposed on the base portion 530 corresponding to the fourth protrusion portion 554 and a sixth fastening portion 576 may be disposed in the fourth protrusion portion 554.

In such a configuration, the fastening portions 571, 573, and 575 are disposed along the first alignment line L1, and the fastening portions 572, 574, and 576 may be disposed along the second alignment line L2. The two alignment lines L1 and L2 are disposed parallel to each other along a longitudinal direction of the end plate 500, and the fastening portions disposed on each line may be disposed so that positions are staggered in an alternating manner.

Furthermore, in FIG. 13, not only are fastening portions disposed in all of the protrusion portions 551, 552, 553 and 554, but fastening portions may also be further disposed at arbitrary points on the base portion 530. by such a structure, fastening portions form a plurality of alignment lines over the entire protrusion portion and base portion, and the end plate 500 includes a multi-alignment structure in which a plurality of fastening lines overlap.

For example, in FIG. 13, the fastening portion 570 may be disposed on the base portion 530 corresponding to the second protrusion portion 552 and the third protrusion portion 553, and the fastening portion 570 may not be disposed on the base portion 530 corresponding to the first protrusion portion 551 and the fourth protrusion portion 554.

Such a multi-alignment structure may prevent a load from being concentrated in a limited region upon fastening, and may improve structural stability by causing the load to be evenly distributed over the entire base portion 530. Furthermore, as fastening portions are disposed extending to arbitrary points of the base portion, design flexibility that may freely adjust a fastening position according to an installation condition of the end plate 500 or a shape of a support member may be secured.

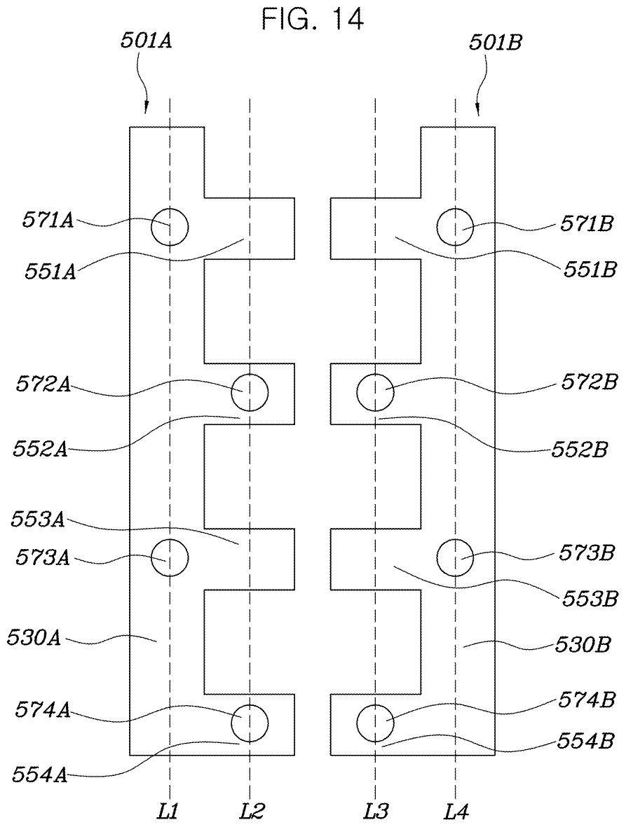

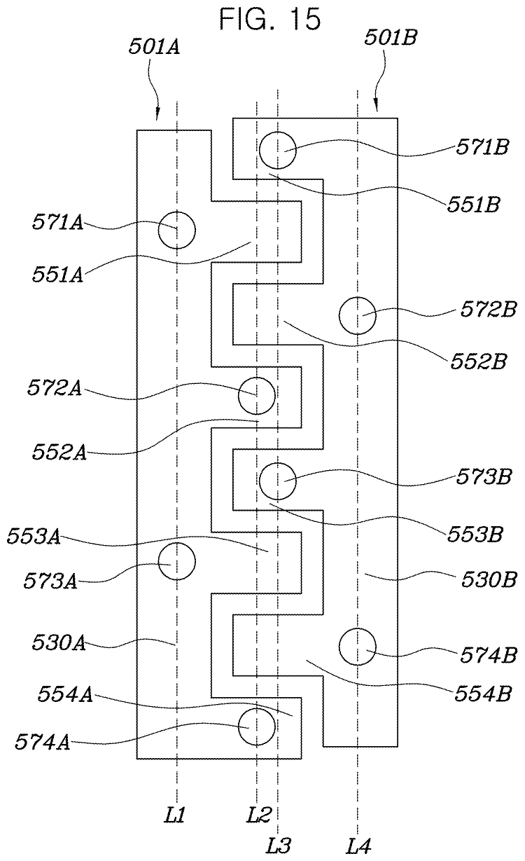

Next, the fastening portion 570 forming a plurality of alignment lines on adjacent end plates 501A and 501B will be described with reference to FIG. 14, and FIG. 15.

FIG. 14 is a view showing an example of fastening portion arrangement between adjacent end plates of the present disclosure, and FIG. 15 is a view showing another example of fastening portion arrangement between adjacent end plates of the present disclosure.

FIG. 14 shows an example in which a first end plate 501A and a second end plate 501B are disposed to be adjacent to each other, and end portions of the protrusion portions 550 of the two end plates 501 are disposed to face each other along an extension direction (first direction) of the support member 300.

That is, along a second direction crossing the first direction in which the support member 300 extends, end portions of protrusion portions of both end plates are disposed in a form corresponding at symmetrical positions.

The first end plate 501A includes a plurality of protrusion portions 551A, 552A, 553A and 554A protruding outwardly from a base portion 530A, and fastening portions 571A, 572A, 573A and 574A may be disposed in each of the protrusion portions 551A, 552A, 553A and 554A or in the base portion 530A corresponding to each protrusion portion.

Correspondingly, the second end plate 501B includes a plurality of protrusion portions 551B, 552B, 553B and 554B protruding from a base portion 530B, and fastening portions 571B, 572B, 573B and 574B may also be disposed in each of the protrusion portions 551B, 552B, 553B and 554B or in the base portion 530B corresponding to each protrusion portion.

At the present time, fastening portions disposed in the first end plate 501A and the second end plate 501B may be disposed in a mutually symmetrical shape as in FIG. 14, or may be disposed in an arbitrary shape for each end plate. At the instant time, the arbitrary shape may include the arrangement shapes of FIG. 9, FIG. 10, FIG. 11, FIG. 12, and FIG. 13 described above.

At the present time, fastening portions of the two end plates 501A and 501B are disposed along a plurality of alignment lines L1, L2, L3 and L4, fastening portions of the first end plate 501A are disposed along the first and second alignment lines L1 and L2, and fastening portions of the second end plate 501B may be disposed along the third and fourth alignment lines L3 and L4.

That is, the protrusion portions 551A, 552A, 553A, and 554A of the first end plate 501A and the protrusion portions 551B, 552B, 553B, and 554B of the second end plate 501B are disposed to face each other, and both end plates 501A and 501B may be disposed facing each other.

In such a structure, since protrusion portions of the two end plates are symmetrically disposed, a load occurring upon fastening may be evenly transmitted to both sides. Furthermore, since fastening portions are located at corresponding points of the same height, a fastening mechanism may be inserted in a straight direction, and effects of simplification of an assembly process and improvement of alignment precision may be obtained.

FIG. 15 is an example showing a structure in which end portions of protrusion portions of the first end plate 501A and the second end plate 501B are disposed to alternately cross each other.

The first end plate 501A includes a base portion 530A and a plurality of protrusion portions 551A to 554A, and fastening portions 571A, 572A, 573A and 574A are disposed in each protrusion portion. A second end plate 501B corresponding thereto includes a plurality of protrusion portions 551B, 552B, 553B and 554B protruding from a base portion 530B, and fastening portions 571B, 572B, 573B and 574B are also disposed in each protrusion portion.

At the present time, as shown in FIG. 15, fastening portions are disposed along a plurality of alignment lines L1, L2, L3 and L4. Fastening portions of the first end plate 501A are disposed along the first and second alignment lines L1 and L2, and fastening portions of the second end plate 501B may be disposed along the third and fourth alignment lines L3 and L4.

End portions of protrusion portions of the first end plate 501A form a relationship of crossing each other along a second direction crossing a first direction in which the support member 300 extends with corresponding end portions of protrusion portions of the second end plate 501B.

According to such a crossed structure, a spacing between adjacent protrusion portions 550 may be efficiently utilized while fastening portions 570 may be disposed without being excessively dense. Furthermore, since the fastening portions 571A, 572A, 573A and 574A of the first end plate 501A and the fastening portions 571B, 572B, 573B and 574B of the second end plate 501B are alternately located on different alignment lines, interference between bolts may be prevented upon fastening.

Although shown and described in relation to specific embodiments of the present disclosure, it is obvious to those of ordinary skill in the art to which the present disclosure belongs that the present disclosure may be variously improved and changed within a limit not departing from the technical spirit of the present disclosure disposed by the following claims.

What is claimed is:

1. A battery assembly comprising:
a support member disposed in a battery case;
a battery cell array configured with a plurality of battery cells and accommodated in the battery case so that the battery cells are disposed at one side of the support member in a stacked and pressurized state;
an end plate disposed at an upper end portion of the support member and pressurizing the battery cells from an external side of the battery cell array; and
a fastening mechanism fastening the end plate and the support member in a vertical direction.

2. The battery assembly of claim 1, wherein a direction in which the support member supports the battery cell array and a direction in which the end plate pressurizes the battery cell array are identical to each other.

3. The battery assembly of claim 1, wherein the end plate is disposed in a plate shape and disposed between the support member and the battery cell array, a first side surface of the end plate is in contact with the battery cell array to pressurize the battery cells, and a protrusion portion protruding in a direction toward the support member and covering an upper surface of the support member is disposed on a second side surface of the end plate.

4. The battery assembly of claim 3,
wherein the end plate further includes a base portion extending in a direction in which the support member extends between the first side surface and the second side surface, and
wherein the fastening mechanism is connected to the upper surface of the support member by passing through the end plate in a state of being disposed on an upper surface of the base portion or the protrusion portion.

5. The battery assembly of claim 3, wherein the protrusion portion protrudes on the end plate in a direction from a first side toward a second side of the support member and extends to cover a center portion disposed between the first side and the second side of the support member.

6. The battery assembly of claim 3, wherein the second side surface of the end plate includes the protrusion portion disposed at an upper portion thereof, and as a lower portion thereof is disposed between the support member and the battery cell array, the support member includes an upper surface covered by the protrusion portion and one side surface facing the battery cell array covered by the second side surface of the end plate.

7. The battery assembly of claim 3, wherein adjacent end plates among end plates are disposed so that protrusion portions alternately cross each other at the upper surface of the support member.

8. The battery assembly of claim 1,
wherein the end plate includes a base portion disposed between a first side surface thereof in contact with an external side of the battery cell array and a second side surface thereof in contact with the support member and extending along a direction in which the support member extends,
wherein a protrusion portion protruding outwardly to cover an upper surface of the support member is disposed on the base portion, and
wherein a fastening portion into which the fastening mechanism is inserted is disposed in the base portion and the protrusion portion.

9. The battery assembly of claim 8, wherein the protrusion portion is disposed at a point between adjacent fastening portions among fastening portions disposed in the base portion on the base portion.

10. The battery assembly of claim 8, wherein the protrusion portion is disposed at a point corresponding to a point at which the fastening portion is disposed on the base portion.

11. The battery assembly of claim 8, wherein a plurality of protrusion portions are disposed to be spaced apart from each other, and fastening portions are alternately disposed at a point corresponding to a point at which a first protrusion portion among the plurality of protrusion portions is disposed on the base portion and at a second protrusion portion adjacent to the first protrusion portion among the plurality of protrusion portions.

12. The battery assembly of claim 8, wherein a plurality of protrusion portions are disposed to be spaced apart from each other, and a protrusion portion in which the fastening portion is not disposed among the plurality of protrusion portions is disposed between adjacent protrusion portions in which the fastening portion is disposed among the plurality of protrusion portions.

13. The battery assembly of claim 8, wherein a plurality of protrusion portions are disposed to be spaced apart from each other, and the fastening portion disposed in the base portion is disposed at a point corresponding to a protrusion portion in which the fastening portion is not disposed among the plurality of protrusion portions.

14. The battery assembly of claim 8, wherein a plurality of protrusion portions are disposed to be spaced apart from each other, the fastening portion is disposed in each of the protrusion portions, and the fastening portion disposed in the base portion is disposed at a point corresponding to a position at which the protrusion portion is formed.

15. The battery assembly of claim 8, wherein the fastening portion is disposed on an alignment line disposed on the end plate to extend in a direction in which the support member extends.

16. The battery assembly of claim 15,
wherein a plurality of alignment lines are disposed on the base portion or the protrusion portion, and
wherein fastening portions respectively disposed on adjacent to alignment lines among the plurality of alignment lines are alternately staggered with each other on the base portion or the protrusion portion.

17. The battery assembly of claim 8, wherein a protrusion portion of a first end plate among end plates is disposed to alternately cross a protrusion portion of a second end plate disposed to be adjacent to the first end plate in a first direction in which the support member extends.

18. The battery assembly of claim 8, wherein a protrusion portion of a first end plate among end plates is disposed so that an end portion thereof faces an end portion of a protrusion portion of a second end plate disposed to be adjacent to the first end plate among end plates in a second direction crossing a first direction in which the support member extends.

19. The battery assembly of claim 1, wherein a fastening hole to which the fastening mechanism is coupled is disposed in each of the end plate and the support member, and the fastening mechanism includes a bolt inserted into the fastening hole to couple the end plate and the support member by bolting.

20. The battery assembly of claim 19, wherein a pop nut including a head portion disposed in a direction toward the end plate is coupled to the fastening hole of the support member, and a lower surface of the end plate is disposed at an upper end portion of the support member by being accommodated on the pop nut.
